(19) United States
(12) Patent Application Publication
(10) Pub. No.: US 2013/0335482 A1
(43) Pub. Date: Dec. 19, 2013

(54) PRINTING APPARATUS WITH ADJUSTING MEMBER

(71) Applicant: Hon Hai Precision Industry Co., Ltd., (US)

(72) Inventor: YU-JEN TSAO, New Taipei (TW)

(73) Assignee: HON HAI PRECISION INDUSTRY CO., LTD., New Taipei (TW)

(21) Appl. No.: 13/785,085

(22) Filed: Mar. 5, 2013

(30) Foreign Application Priority Data
Jun. 14, 2012 (TW) 101121420

(51) Int. Cl. B41J 25/00

(52) U.S. Cl. CPC B41J 25/001
USPC 347/37

(57) ABSTRACT

A printing apparatus includes a mounting plate, a driving module attached to the mounting plate, a driven module secured to the mounting plate, an endless belt connecting the driving module and the driven module, a resisting member slidably engaged with the driven module, and an adjusting member rotatably secured to the mounting plate and pressing the resisting member on the driven module. The adjusting member can be loosened and tightened. When the adjusting member is loosened, the driven module is movable relative to the mounting plate along a first direction by urging of the endless belt. When the adjusting member is tightened, the driven module is still movable relative to the mounting plate along a second direction opposite to the first direction, by pressure from the resisting member.

### BACKGROUND

1. Technical Field

The present disclosure relates to printing apparatuses, and more particularly to a printing apparatus with an adjusting member.

2. Description of Related Art

A printer may include a printing module and a print head moving module for driving the printing module across a piece of paper. Tension of an endless belt transmitting motion to the printing module may be provided by a spring. However, the spring may be too flexible and apply inappropriate tension in the belt. If the belt is not at the correct tension, printing quality may decrease. Therefore, an improved printing apparatus is desired.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of a printing apparatus.

FIG. 2 is similar to FIG. 1, but shown from a different aspect.

FIG. 3 is an assembled view of the printing apparatus of FIG. 1, an endless belt is not shown.

FIG. 4 is another assembled view of the printing apparatus of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

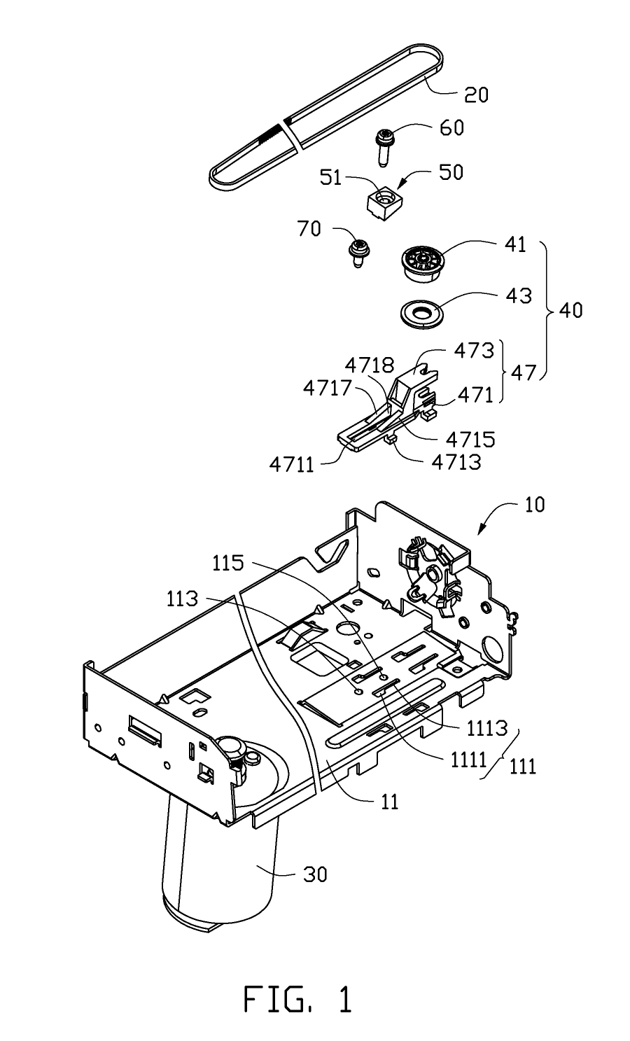

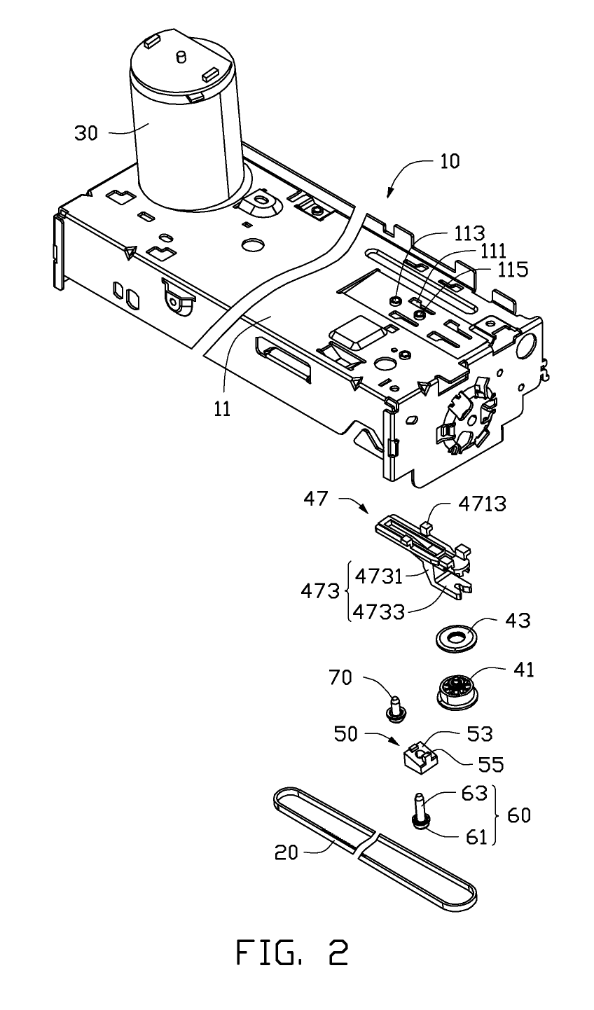

FIGS. 1-4 illustrate a printing apparatus in accordance with an embodiment. The printing apparatus includes a bracket 10, an endless belt 20, a driving module 30 attached to the bracket 10, a driven module 40, a resisting member 50, and an adjusting member 60.

The bracket 10 includes a mounting plate 11. The mounting plate 11 defines four latch slots 111, a locking hole 113, and a threaded hole 115. The four latch slots 111 are arranged near the four corners of a rectangular area, and each of the four latch slots 111 includes a wide portion 1111 and a narrow portion 1113 which communicates with the wide portion 1111. The locking hole 113 and the threaded hole 115 are located in one line and positioned between two of the four latch slots 111.

The driven module 40 includes a driven wheel 41, a gasket 43 attached to the driven wheel 41, and a limiting base 47 slidably secured to the mounting plate 11. The limiting base 47 includes an elongated installation board 471 and a clipping portion 473 located on one side of the installation board 471. The installation board 471 defines an elongated sliding slot 4711. Four latch portions 4713 extend from another side of the installation board 471 and are arranged near the same four corners of the same rectangular area. The clipping portion 473 includes a connecting board 4731 connected to the installation board 471 and a clipping board 4733 extending from the connecting board 4731. Two supporting blocks 4715 extend from the connecting board 4731. The two supporting blocks 4715 cooperatively define a slit 4718 communicating with the sliding slot 4711. Each of the two supporting blocks 4715 has a slanted supporting surface 4717 for supporting the resisting member 50. The clipping board 4733 and the installation board 471 are parallel to each other and can clip the driven wheel 41 and the gasket 43 in place.

The resisting member 50 includes a slanted resisting surface 53 and defines a through hole 51 extending through the slanted resisting surface 53. Two limiting blocks 55 extend from the slanted resisting surface 53 and are located on two opposite sides of the through hole 51.

The adjusting member 60 includes a head portion 61 and an inserting portion 63 extending from the head portion 61. The adjusting member 60 may be a screw or bolt, for example.

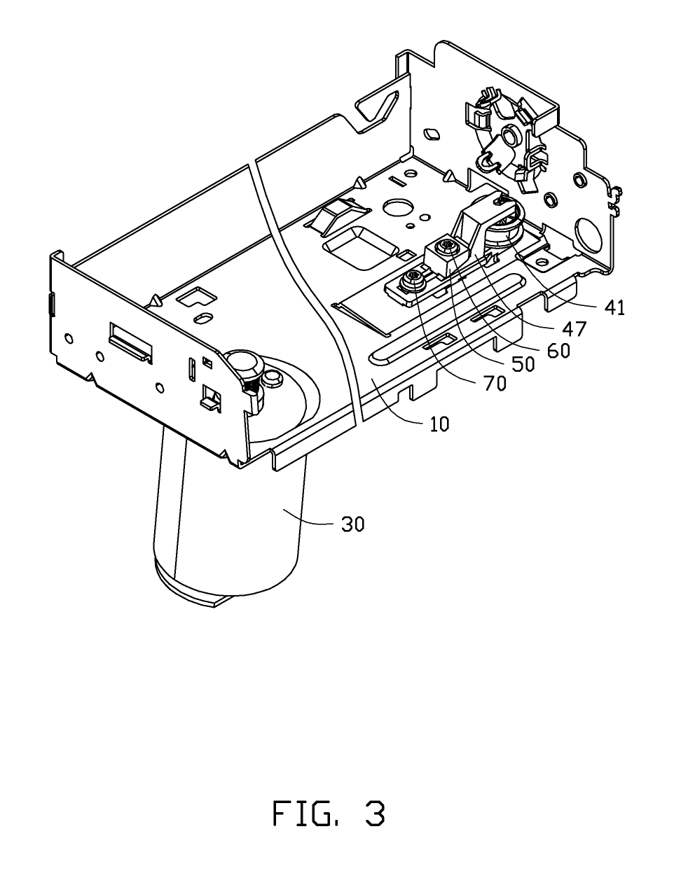

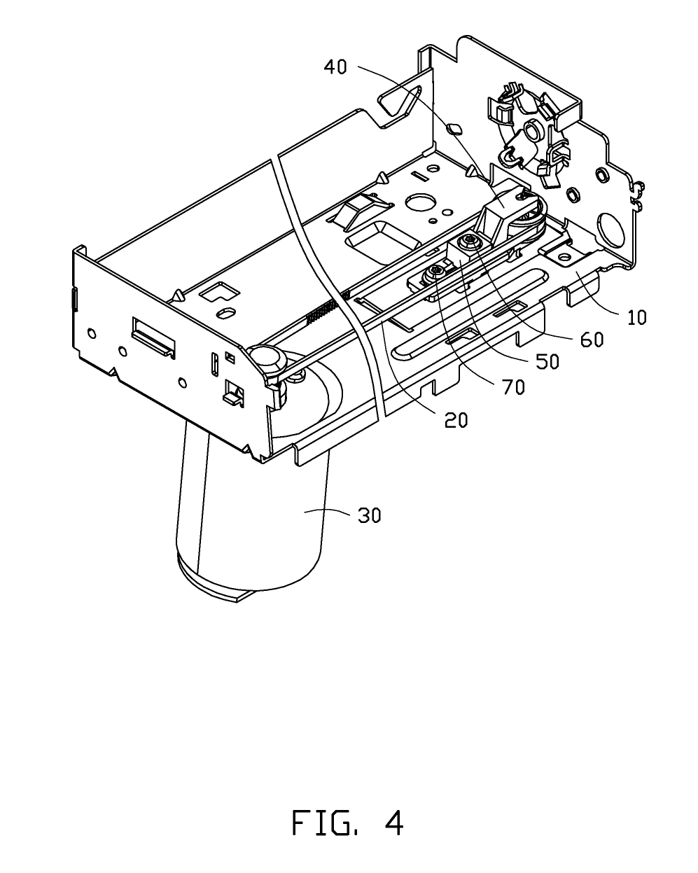

Referring to FIGS. 3 and 4, in assembly, the gasket 43 and the driven wheel 41 are rotatably clipped between the clipping board 4733 and the installation board 471. The four latch portions 4713 of the limiting base 47 are inserted into the wide portion 1111 of the four sliding slots 111. The limiting base 47 is pushed until each of the latch portions 4713 is engaged into the narrow portion 1113. A locking member 70, such as a screw, extends through the sliding slot 4711 to be engaged into the locking hole 113. The locking member 70 abuts the limiting base 47 for locking the limiting base 47 to the mounting plate 11. The endless belt 20 surrounds a head of the driving module 30 and the driven wheel 41.

In assembly of the resisting member 50, the two limiting blocks 55 are inserted into the slit 4718 of the limiting base 47, and the slanted resisting surface 53 abuts the slanted supporting surface 4717. The inserting portion 63 of the adjusting member 60 extends through the through hole 51 and the slit 4718 to be engaged into the threaded hole 115.

In use, the adjusting member 60 is loosened, the endless belt 20 urges the driven module 40 to move. The limiting base 47 of the driven module 40 is moved towards a first direction, until a tension of the endless belt 20 is adjusted to a predetermined value.

The adjusting member 60 is tightened, and the resisting member 50 abuts the limiting base 47. The limiting base 47 is moved along a second direction opposite to the first direction, until the tension of the endless belt 20 is again adjusted to the predetermined value.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A printing apparatus comprising:
a bracket comprising a mounting plate;
a driving module secured to the mounting plate;
a driven module engaged with the mounting plate;
an endless belt connecting the driving module with the driven module;
a resisting member slidably engaged with the driven module; and
an adjusting member rotatably secured to the mounting plate and pressing the resisting member on the driven module;
wherein the adjusting member is moveable relative to the resisting member between a fixed position and an unfixed position; when the adjusting member is in the unfixed position, the driven module is movable relative to the mounting plate along a first direction by the endless belt biasing; when the adjusting member is in the fixed position, the driven module is movable relative to the mounting plate along a second direction opposite to the first direction by the resisting member biasing.

2. The printing apparatus of claim 1, wherein the driven module comprises a limiting base, the limiting base comprises an installation board and a clipping portion on the installation board, the installation board is slidably engaged with the mounting plate, and the resisting member is engaged with the clipping portion.

3. The printing apparatus of claim 2, wherein the clipping portion defines a slanted supporting surface, the resisting member defines a slanted resisting surface, and the slanted resisting surface abuts the slanted supporting surface.

4. The printing apparatus of claim 3, wherein an acute angle is defined between the slanted supporting surface and the mounting plate, and the slanted resisting surface is substantially parallel to the slanted supporting surface.

5. The printing apparatus of claim 2, wherein the installation board defines an elongated sliding slot, the clipping portion defines a slit communicating with the sliding slot, the resisting member defines a through hole, the mounting plate defines a threaded hole, and the adjusting member extends through the through hole, the slit, and the sliding slot to be engaged into the threaded hole.

6. The printing apparatus of claim 5, wherein the resisting member comprises two limiting blocks, and the two limiting blocks are engaged in the slit.

7. The printing apparatus of claim 2, wherein four latch portions are located on the installation board, the mounting plate defines four latch slots correspondingly positioned relative to the four latch portions, each of the four latch slots comprises a wide portion and a narrow portion communicating with the wide portion, and each of four latch portions extends through the wide portion to be engaged in the narrow portion.

8. The printing apparatus of claim 7, wherein each of the four latch portions is positioned at each corner of a first rectangular, and each of the four latch slot is positioned at each corner of a second rectangular.

9. The printing apparatus of claim 2, wherein the driven module further comprises a driven wheel and a gasket, and the driven wheel and the gasket are clipped between the clipping portion and the installation board.

10. The printing apparatus of claim 9, wherein the clipping portion comprises a connecting board and a clipping board extending from the connecting board, and the driven wheel and the gasket are clipped between the clipping board and the installation board.

11. A printing apparatus comprising:
a bracket comprising a mounting plate;
a driving module secured to the mounting plate;
a driven module comprising a limiting base, the limiting base being engaged with the mounting plate;
an endless belt connecting the driving module with the driven module;
a resisting member slidably engaged with the driven module; and
an adjusting member rotatably secured to the mounting plate and pressing the resisting member on the driven module,
wherein when the adjusting member is in an unfixed position, the limiting base is movable relative to the mounting plate along a first direction by the endless belt biasing;
when the adjusting member is in a fixed position, the limiting base is movable relative to the mounting plate along a second direction opposite to the first direction by the resisting member biasing.

12. The printing apparatus of claim 11, wherein the limiting base comprises an installation board and a clipping portion on the installation board, the installation board is slidably engaged with the mounting plate, and the resisting member is engaged with the clipping portion.

13. The printing apparatus of claim 12, wherein the clipping portion defines a slanted supporting surface, the resisting member defines a slanted resisting surface, and the slanted resisting surface abuts the slanted supporting surface.

14. The printing apparatus of claim 13, wherein an obtuse angle is defined between the first direction and the slanted supporting surface, and an acute angle is defined between the slanted supporting surface and the second direction.

15. The printing apparatus of claim 13, wherein an acute angle is defined between the slanted supporting surface and the mounting plate, and the slanted resisting surface is substantially parallel to the slanted supporting surface.

16. The printing apparatus of claim 12, wherein the installation board defines an elongated sliding slot, the clipping portion defines a slit communicating with the sliding slot, the resisting member defines a through hole, the mounting plate defines a threaded hole, and the adjusting member extends through the through hole, the slit, and the sliding slot to be engaged into the threaded hole.

17. The printing apparatus of claim 16, wherein the resisting member comprises two limiting blocks, and the two limiting blocks are engaged in the slit.

18. The printing apparatus of claim 12, wherein four latch portions are located on the installation board, the mounting plate defines four latch slots correspondingly positioned relative to the four latch portions, each of the four latch slots comprises a wide portion and a narrow portion communicating with the wide portion, and each of four latch portions extends through the wide portion to be engaged in the narrow portion.

19. The printing apparatus of claim 18, wherein each of the four latch portions is arranged at each corner of a first rectangular, and each of the four latch slot is arranged at each corner of a second rectangular.

20. The printing apparatus of claim 12, wherein the driven module further comprises a driven wheel and a gasket, and the driven wheel and the gasket are clipped between the clipping portion and the installation board.
